(19) United States
(12) Patent Application Publication
(10) Pub. No.: US 2002/0069256 A1
(43) Pub. Date: Jun. 6, 2002

(54) World-wide-web vending machinesTM

(76) Inventor: Anuthep Benja-Athon, New York, NY (US)

Correspondence Address: ANUTHEP BENJA-ATHON, M.D., Pain Management Rehabilitation Medicine, Acupuncture Physical Therapy, 210 East 36th Street, New York, NY, 10016, US

(21) Appl. No.: 09/730,009

(22) Filed: Dec. 6, 2000

(51) Int. Cl. G06F 15/16

(52) U.S. Cl. 709/217; 709/231

(57) ABSTRACT

World-Wide-Web Vending Machines™ is a network of vending machines of electronic information. The vending machine members are linked by wire, cable and wireless. Each member comprises receiving, memory, displaying and disseminating units to receive, store, manipulate, retrieve, display and dispense electronic, electronically transformed and electronically stored information. Each member comprises a receiving unit which receives information from various sources, software unit to selectively manipulate subsets of information. It comprises a viewing screen to display information and a disseminating unit to transmit, transfer and beam information. It comprises a printer and a binding device for making copy. Moreover, the invention provides a method of disseminating electronic, electronically transformed and stored information by a network of vending machines.

### FIELD OF INVENTION

World-Wide-Web Vending Machines™ for dispensing electronic books and the like.

### BACKGROUND OF THE INVENTION

The first objective of the present invention is to extend the reach of people for information which is inaccessible to almost all people.

The second objective is to make available information to all people who have neither a computer, access to the Internet and the like nor said information.

The third objective is to provide an inexpensive means and a readily accessible means and device for obtaining and disseminating information in both electronic and printed versions for all people.

The fourth objective is a long-term goal to improve the socioeconomic, standard of living and, consequently, quality of life of all people.

Despite a great leap in technology represents by computer networking and the Internet, the majority of people in America and the world are kept out of the information superhighway. One of the reasons is the accessibility to a computer and its accessories including costly and complicated softwares and the information. As a result the vast majority of people in this world continue to be left behind in the socioeconomic advancement enjoyed by fews.

Even among skilled computer operators, easy and expeditious access to information is still lacking. The task can be very daunting for this minority who may be lucky to hit the target after a long and tedious search. This is because of the archaic means and method of storing, accessing and retrieving information.

The present invention overcomes said problems and obstacles and fulfills said objectives.

### SUMMARY OF THE INVENTION

One of the fundamental obstacles to the betterment of human society is the fact that almost all people have no access to information infra. This is due to the archaic means and method of storing and retrieving information and the lack of means for dispensing said information.

The present invention is a World-Wide-Web Vending Machines™ which is a network of dispensing and vending machines of electronic, electrically transformed and stored books, texts, articles, magazines, journals, publications and news. The vending machine members of the Machines are scattered throughout the world and are accessible in public places. Said vending machine members are linked by wire, cable. wireless and various types of hand-held devices, computers and information-storing means and devices.

Said vending machine comprises receiving, memory, software, displaying and disseminating units to receive, store, manipulate, retrieve, display and dispense electronic, electronically transformed and electronically stored information such as electronic books, texts, publications, magazines, journals and news. Said member comprises a receiving unit which receive information from various sources by wire, cable and wireless including satellites, software unit to selectively manipulate, search, hyperlink, mark, note, highlight, cut, copy, paste, edit and merge subsets of information.

It comprises a viewing screen to display the original and abridged versions of the information and a disseminating unit adaptable to transmit, transfer and beam information to a satellite, hand-held device and computer, information-storing disks and tapes, desk-top computer, laptop configuration and television. It further comprises a printer and a binding device for making copy. A binding unit is also provided to bind printed pages into bound copy.

Moreover, the invention also provides a method of disseminating the use and application of electronic, electronically transformed and stored books, publications, magazines, journals and news by a network of vending machines named supra. Each vending machine member comprises aforementioned components adaptable to receive, store, manipulate, retrieve, display, disseminate and transfer original and abridged versions of the stored information. The information is transferred and transmitted by wire, cable, wireless, magnetic and electromagnetic means to other machine members, satellite, hand-held devices, information-storing and -relaying devices, desk-top computer, laptop configuration, television and the like and printer. The method also provides the use of a binding unit for binding printed pages into bound copy.

### DESCRIPTION OF THE PREFERRED EMBODIMENTS

The present invention is the World-Wide-Web Vending Machines™ Comprises a network of machines vending or dispensing electronic information scattered throughout the world. The Machines is represented by its individual component machine 1.

Machine 1 stores, manipulates, displays, retrieves and dispenses electronic, electronically transformed and electronically stored books, texts, publications, magazines, journals, news and the like in the original version and also in abridged version. Said stored books, texts, publications, magazines, journals, news in machine 1 can be derived from various sources such as, but not limited to, keyboarding, scanning, voice-entry of said information into a computer.

Machine 1 and its clones can be located in locations scattered throughout the world and in public places such as airports, shopping malls and supermarkets, villages, remote areas and in vehicles such as buses, airplanes and spacecrafts.

Machine 1 and its clones are linked or connected by wireless means including satellites, wire and cable means for transferring of said entities. Furthermore, said movement and transfer of said information can be achieved with other device means for storing, relaying and transferring of information such as, but not limited to, hand-held computer including laptop configuration and various types of tapes and diskettes including zip diskette. Other hand-held device means can also be used such as, but not limited to, cellular mobile phone, PALM, HANDSPRING, C-PEN, their clones and the like. As a result, the information in World-Wide-Web Vending Machines™ is constantly and instantly acquired, captured and up to date.

Machine 1 in one of the preferred embodiments is a self-contained, integrated unit comprises a reception unit means for receiving said information, a memory unit means for storing and retrieving said information, a computer software unit for selectively manipulating, searching, hyperlinking, marking noting, highlighting, cutting, copying, pasting, editing and merging said information and subsets of information, a display unit means for displaying said information, a wireless and wire means for transferring said information, a means for printing said information into copy, and a means for binding copy of said information.

Of course, it is obvious to one skill in the art that any of said integrated components may be isolated from machine 1 for technical and ease-of-application reasons. However, all components are still connected to machine 1 by wireless and wire means including cable means. For example, in a vehicle such as an airplane, a passenger would want to view and work with said information on a viewing screen while seated in his or her seat away from other said components of machine 1. Moreover, said passenger in said setting may want to retrieve, store and disseminate said information in various settings as discussed herein.

Included in machine 1 is the financial transaction unit adaptable to receive payments in the form of currencies, debit and credit cards, checks, notes and the like and to transmit by wireless and wire means and to check the worthiness of said forms of transaction. Machine 1 also comprises a unit to dispense returns including receipts, bills and changes.

Machine 1 comprises a receiving unit such as, but not limited to, satellite dish, antenna, scanner, cache and drives, and various computer port means for receiving electronic, electromagnetic, magnetic, wireless, wire and cable transmission of said information. With said unit, the contents of information in machine 1 are always up to date and also can be retrieved on demand even though said information may not be in machine 1 at that instant moment of demand. Said information can be retrieved by machine 1 from a distant means for storing of information at a different location from a particular demanding machine 1.

Machine 1 has keyboard, touch-sensitive screen and voice-recognition means for an operator to communicate with machine 1 and vice versa.

Machine 1 comprises a computer, laptop configuration, television with all the cache and memory drives and the like adaptable to continually store, retrieve, display, dispense and disseminate said information received and stored. From the memory unit in machine 1 or in the remote computer server, a computer software unit adaptable to selectively manipulate, search, hyperlink, mark, note, highlight, cut, copy, paste, edit and merge concepts, principles, analogies, parallelism and issues in said information. Subsets of information having similar, analogous or parallel concept, principle, contents, etc. are located in said electronic, electronically transformed and stored books, texts, stories, publications, magazines, journals, news and the like. For example, a similar concept in several books, texts, journals, publications, news and the like can be selectively searched, manipulated, hyperlinked, marked, noted, highlighted, cut, copied, pasted, edited and merged into one resultant set of information being displayed before or conveyed to said operator. The result is information that is available as an abridged version of said information in addition to said original information. Furthermore, said result can be stored in said memory unit of machine 1 for future use and references.

By means such as, but not limited to, wireless, satellite, magnetic, electronic, electromagnetic, wire and cable means for conveying and transferring said books, texts, articles, publications, magazines, journals and newspapers can be continually, simultaneously and instantaneously transferred, disseminated and updated in said computer component of machine 1 and its clones. To view said information, machine 1 has a viewing screen or voice means for disseminating said information such as a speaker for the visual-impaired. For visual-auditory impaired persons, tactile means for disseminating information is incorporated into machine 1 such as, but not limited to, computer-generated Braille.

Of course, in the event that said operator does not want to stand by machine 1 to assimilate said information a wire means and wireless means for transferring and removing said information from machine 1 is available. Machine 1 adaptable to transfer said information by wire and wireless means for transferring said information to any hand-held device, computer, laptop configuration, television, information-receiving, -storing and -retrieving device and the like. In using wireless means, machine 1, for example, beams said information to a satellite, disseminate said information by electronic, magnetic electromagnetic means including light such as infrared beam and the like to said devices. Some popular hand-held device means for receiving, storing, retrieving, transferring and displaying said information are such as, but not limited to, hand-held computer including laptop configuration and various types of tapes and diskettes including zip diskette. Other hand-held devices such as, but not limited to, cellular mobile phone, PALM, HANDSPRING, C-PEN, their clones and the like. Said devices can be transferred said information for machine 1 using the wireless and wire features in said devices such as, but not limited to, ports, scanner, cradle, wire and cable.

Of course, in the event that said operator does not want to stand by machine 1 to assimilate said information and does not have said devices, a wire means and wireless means for transferring and removing said information from machine 1 is available. Machine 1 adaptable to transfer said information by wire and wireless means for transferring said information to any printer in, adjacent to and remote from machine 1. Wireless transfer is discussed supra. Said printer reproduces and collates the printed copy. For example, in a vehicle such as airplane, a passenger would want to have said copy while in the airplane or said copy may be forwarded to any destination remote from said airplane using said means. Further to same, audio version of said product is available for visual-impaired and sighted persons.

Machine 1 also has a means for binding pages into copy of said information as a component of said machine. In a preferred embodiment said means for binding said pages is located adjacent to or remote from machine 1. Said means for binding pages comprises a staple means for binding said pages. Said staple means for binding uses plastic or metallic staple means for stapling pages into copy. Plastic rods or strips are incorporated in the process of binding to form the spine of said copy.

In other preferred embodiments, said means for binding comprises a pressing means for binding pages into copy or a heat-activated means for binding pages using a heat-sensitive plastic strip incorporating a heat-activated glue means for binding pages and spine of pages.

Consequently, for example, a scientist in most remote area of the world or a passenger in an airplane can access and manipulate the same information with equal adapt and resource as a scientist at some of the most prestigious and well-endowed institutions. In another setting, a person in a shopping mall can access and manipulate any and all information one so need, desire and choose.

Although various preferred embodiments of this invention have been described, it will be appreciated by those skilled in the art that adaptable and variation may be made without departing from the spirit of the invention or the scope of the claims.

Although various preferred embodiments of this invention have been described to apply to said books, texts, articles, publications, magazines, journals and newspapers, it will be appreciated by those skilled in the art that the application described herein does apply to other document, article and item means for conveying information and human thought and feeling without departing from the spirit of the invention or the scope of the claims.

1. A vending machine means for receiving, storing, retrieving, displaying and dispensing information using wire means and wireless means for said streaming and storing of said information wherein subsets of information in said information are selectively searched, hyperlinked, marked, noted, highlighted, cut, copied, pasted, edited and merged and wherein said machine means adaptable to link to same located at other locations and to transfer said original and abridged information by said wire and wireless means for transferring and storing to said same, a satellite, relaying server, hand-held device, information-storing, desk-top computer, laptop configuration and television means for receiving, storing, relaying and displaying said information and to copy comprises:
a reception unit means for receiving said information;
a memory unit means for storing and retrieving said information;
a manipulating means for selectively manipulating, searching, hyperlinking, marking, noting, highlighting, cutting, copying, pasting, editing and merging said subsets of information;
a display unit means for displaying said information;
a voice-generating unit means for transferring said information;
said wireless means for transferring said information;
said wire means for transferring said information;
a means for printing said information into copy; and
a means for binding copy of said information.

2. A vending machine means for receiving, storing, retrieving, displaying and dispensing electronic, electronically transformed and electronically stored books, publications, magazines, journals and news using wire means and wireless means for said moving and transferring of information wherein subsets of information in said information are selectively manipulated, searched, hyperlinked, marked, noted, highlighted, cut, copied, pasted, edited and merged and wherein said machine means adaptable to link to same in different locations and to transfer said original and abridged information by said wire and wireless means for moving and transferring to said same, a satellite, relaying server, hand-held device, information-storing, desk-top computer, laptop configuration and television means for receiving, storing, relaying and displaying said information and to copy comprises:
a reception unit means for receiving said information;
a memory unit means for storing and retrieving said information;
a manipulating means for selectively manipulating, searching, hyperlinking, marking, noting, highlighting, cutting, copying, pasting, editing and merging said subsets of information;
a display unit means for displaying said information;
a voice-generating unit means for transferring said information;
said wireless means for transferring said information;
said wire means for transferring said information;
a means for printing said information into copy; and
a means for binding copy of said information.

3. A method of disseminating use and application of electronic, electronically transformed and stored books, publications, magazines, journals and news is the use of World-Wide-Web Vending Machine™ means for dispensing said information wherein individual vending machine members adaptable to locate in different locations scattered throughout the world wherein said machine means is linked by wire and wireless means, be accessible to the public, and to receive, store, retrieve, display, disseminate and transfer said original and an abridged version of said information by wire and wireless means for transferring to a satellite, relaying server, hand-held device, information-storing, desk-top computer, laptop configuration and television means for receiving, storing, relaying and displaying said information and to copy using:
a reception unit means for receiving said information;
a memory unit means for storing and retrieving said information;
a manipulating means for selectively manipulating, searching, hyperlinking, marking, noting, highlighting, cutting, copying, pasting, editing and merging subsets of said information;
a display unit means for displaying said information;
an auditory unit means for transmitting said information;
said wireless means for transferring said information;
said wire means for transferring said information;
a means for printing said information into copy; and
a means for binding copy of said information.
